(19) United States
(12) Patent Application Publication
(10) Pub. No.: US 2010/0121695 A1
(43) Pub. Date: May 13, 2010

(54) Web-based marketing method

(75) Inventors: David Everett Benge Ward, Yacolt, WA (US); Christopher L. Hannah, Vancouver, WA (US)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Star Prog, LLC

(21) Appl. No.: 12/291,748

(22) Filed: Nov. 12, 2008

(51) Int. Cl. G06Q 30/00; G06Q 40/00; G06Q 90/00

(52) U.S. Cl. 705/14.12; 705/37; 705/1.1

(57) ABSTRACT

An Internet marketing venue focused around a Web-based casual game. The game is an entertainment site designed for simplicity of play with low commitment. Sponsors provide prizes and rewards, which are made available to the highest-scoring players. These . winners select the prizes they most prefer, while non-winners earn points to be “spent” on rewards they choose. In this way, sponsors are connected to customers with both a proven interest and emotional investment in their products.

### CROSS-REFERENCE TO RELATED APPLICATIONS

This application claims the benefit of provisional application No. 60/018,971 filed Jan. 4, 2008.

### BACKGROUND

The Internet has become a major contributor in the fields of entertainment and new customer acquisition. The disclosed method was created to combine these two dynamic elements in a new and unique manner that both provides enhanced entertainment to the player and enhanced value to the sponsor.

Entertainment on the Internet is growing dramatically, with new games being made available on a weekly, if not daily, basis. The area of casual gaming has seen particular growth, and is expected by The Casual Games Association to reach over $2 billion this year and will continue to grow at about 20% annually. The demographic often cited as the fastest growing is married women and people over 35, which is a principal demographic for many advertisers and sponsors. Internet users are often seeking a diversion that offers both entertainment and information, and provides both with a minimal investment of time and minimal commitment.

Advertisers and sponsors compete on the Internet for new customers using increasingly sophisticated methods. Traditional banner-type advertisements are making way for contextual advertisements, product placement, and multimedia-type ads that invade the content of the Web site and demand attention. The goal for many advertisers is to do more than just garner a casual click from a random Web site visitor. In order to maximize the return for the advertising dollars spent, advertisers attempt to acquire customers that are both demographically suitable to their products and services, as well as having a proved interest in them.

### SUMMARY

A game is offered at no cost to consumers who use computers, for example by creating a Web page accessible over the Internet. Advertisers are invited to offer their wares as prizes and rewards to players of the game. Players who are successful enough at the game to earn a prize or reward may then select which of the offered products they prefer as their prize.

This method has two desirable effects. First, by forcing consumers to earn prizes, rather than simply mailing them coupons or offering giveaways, the game fosters a sense of value akin to that fostered when actual money is spent; the prizes and rewards are not mere throwaways. Second, by allowing consumers to choose which prize they prefer, the advertiser can be sure that the offered good or service is actually useful to and desired by the consumer, and can avoid the wasted expense of, for example, soliciting married consumers for dating services or male consumers for makeup promotions.

The claimed method overcomes some of the shortcomings of the prior art by offering a novel means for connecting advertisers with customers who are interested in their products.

The foregoing and other objectives, features, and advantages of the method will be more readily understood upon consideration of the following detailed description taken in conjunction with the accompanying drawings.

### BRIEF DESCRIPTION OF THE SEVERAL DRAWINGS

FIG. 1: Overall system block diagram of a preferred embodiment.

FIG. 2: Block diagram showing process flow of player registration.

FIG. 3: Block diagram showing flow of game round.

FIG. 4: Block diagram of information flow of event creation.

FIG. 5: Block diagram process flow of player answering questions.

FIG. 6: Block diagram process flow of prize sponsor participation.

FIG. 7: Block diagram process flow of prize bidding.

FIG. 8: Block diagram process flow of premium sponsor participation.

FIG. 9: Block diagram showing process flow of premium redemption.

### DETAILED DESCRIPTION OF PREFERRED EMBODIMENTS

The present method is directed at a system for providing a business with a unique way of acquiring new customers who have demonstrated an interest in the business' products or services.

Traditional promotions such as coupons, giveaways, sweepstakes, etc., share a defect that the newly-acquired customer has no vesting in the company or the goods or services the company has to offer. Further, that customer has had extremely limited contact with the company in terms of time spent evaluating the company and its products and services. If a customer receives a coupon or a giveaway, the customer can sample the product for free and may or may not have future dealings with the company who supplied the product. If a customer fills out a form to enter a sweepstakes, the customer has little or no expectation of winning, no vested interest in the product, and virtually no interaction with the company providing the sweepstakes prize.

The subject method provides a relationship between a customer and the business for an extended period of time through the mechanism of an ongoing Web-based game where the business' products or services are offered either as prizes or rewards. A customer, or more accurately, player, earns points for correctly predicting the outcome of future events, and these points accumulate over time until the end of a round. The top point earners of a round may enter a bidding process where they select their prizes in order of the points they earned. The non-winners may have their round points translated into reward points which accumulate over time. Reward points can be earned by other means as well. Reward points can be redeemed by the player for a tangible reward.

Three elements make this method unique and valuable to businesses offering their products and services as prized and rewards. First, the player accumulates points over time, so the prize or reward is visible to the player over an extended period of time, allowing the business time to present the player with additional information and exposure. Second, the player has to earn the points, and so has the vesting in the points that gives them an intrinsic value—points hard-earned are not to be spent lightly. Third, this intrinsic value in the points is transferred into the prize or reward by the nature of this prize or reward being chosen by the player from a selection. Prizes and rewards are both earned, and chosen, which establishes a relationship between the player and business that would not otherwise exist.

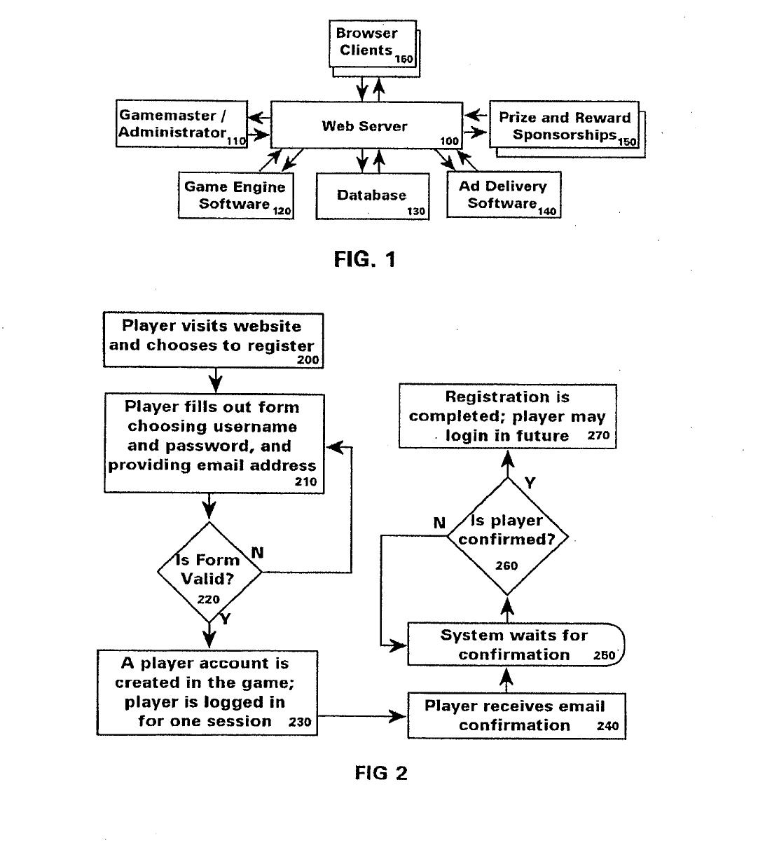

FIG. 1 is an overall block diagram of a preferred embodiment of the present method. In this embodiment, a Web server 100 is a combination of computers called servers and their associated networking hardware, as well as various server software programs. This aggregate Web server 100 is the focal point for all interaction of the other components, accepting input from and generating output to the other components via a network, for example, a local area network. The game master/administrator component 110 is a control component which accesses various elements of the game engine 120, database 130, ad delivery software 140, or prize and premium sponsorships 150. The game engine 120 is a software component that executes on a server computer and provides the Web server 100 with information to present to a browser client 160, as well as executing various periodic and cyclic functions that operate the game. The database 130 is a software component that operates on a server computer and is the central repository of data including, but not limited to, player information such as user names, passwords, and preferences, game information such as questions and answers, advertising data, prize and reward data, control data, and all manner of data required for the computer system to function. The ad delivery software 140 is a software component that executes on a server computer and incorporates various types of advertisements into the output the Web server 100 provides for the browser client 160. Prize and reward sponsorships 150 arc business components that are represented in the method as elements of the game presented to the Web server 100 and presented to the browser client 160. The browser client 160 is a standard software program that runs on a personal computer and is used to view Web sites on the Internet, for example, Internet Explorer or Firefox.

FIG. 2 is a block diagram showing how a new player registers with the game. A player visits the Web site and chooses to register 200. The player fills out a simple form 210 in their browser client which is validated by the game engine software 220. If the information provided by the player is suitable, the game engine software creates a player account 230, and the game engine logs the player in for a single session. The game engine software sends the player an e-mail 240 with a special, coded confirmation link, then waits for the player to click on the link in the future 250. If the game engine software receives the appropriate code as the result of the user clicking the link 260, the game engine software completes the registration 270 and the player is allowed to login in the future.

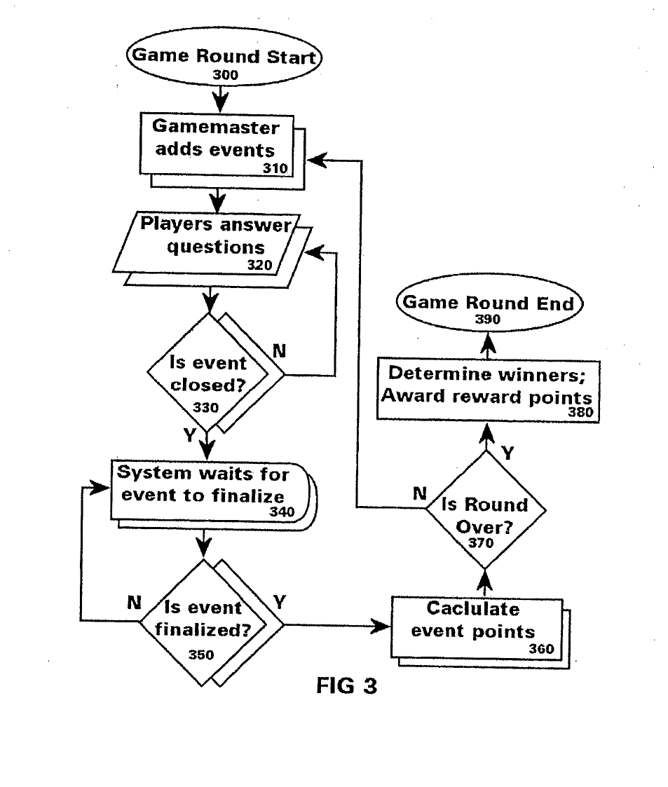

FIG. 3 is a block diagram showing how a game cycle, or round, operates. A round may start 300 immediately upon the conclusion of the prior round in such a manner that there is always one and only one round operating at any given time. The game master may add any events left over from the previous round 310, and continuously adds new events 310 as long as the round is operating. Players visit the site occasionally and answer questions for these events 320 in their browser client, provided the events are open for answering 300. When an event is closed 330, the players can no longer answer questions and the game engine waits until the event is finalized 340 and the correct answers are supplied by the game master 350. When the correct answers are supplied by the game master, the game engine calculates each player's points 360. Adding events 310, answering questions 320, and calculating points 360 repeat until the round is declared to be over by the game master 370. When the round ends the overall points are tabulated, the winners are determined 380, and the non-winners are awarded bonus points 380 equal to the points they earned that round. The round ends 390, and a new round commences immediately 300.

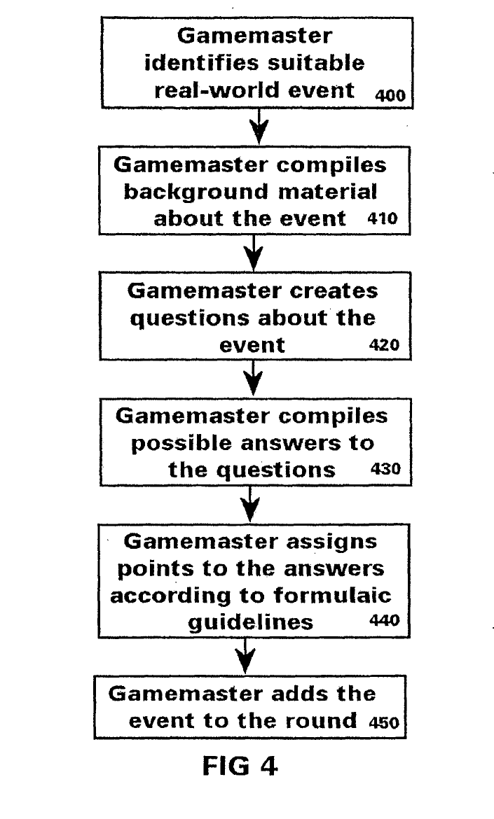

FIG. 4 is a block diagram showing how a game master creates an event to be added to the game round. The game master chooses a suitable real world event 400. This event preferably has a definitive outcome that is in question, is likely to occur within a reasonable period of time, is of interest to a cross-section of the game players, and preferably is not controversial or adult in nature. The game master then does sufficient research on the event 410 to provide the players with an adequate description as well as possible encyclopedic entries on the site. The game master then takes this reference material and creates one or more questions about the event 420 that can have definitive answers. These answers are compiled 430 and checked for completeness so that every reasonable real world outcome is reflected in the answer choices. The game master awards points to the answers 440 in a subjective manner that nevertheless follows some guidelines. First, the societal significance plays a large part in the overall number of points that can be earned for a question. Second, the more questions there are in a given event the fewer points can be earned for each question. Third, the more correct answers there might be for a particular question, the fewer points each of those answers are worth. Fourth, the farther in the future the event will finalize, the more points that can be earned for that question. Fifth, as the round continues, events are worth somewhat more points than their predecessors in general. Sixth, the less likely a particular answer is relative to the other answers in a question, in the opinion of the game master, the more points that answer is worth relative to the others. Once points are assigned, the game master adds the event to the round 450, and the event is made available to players.

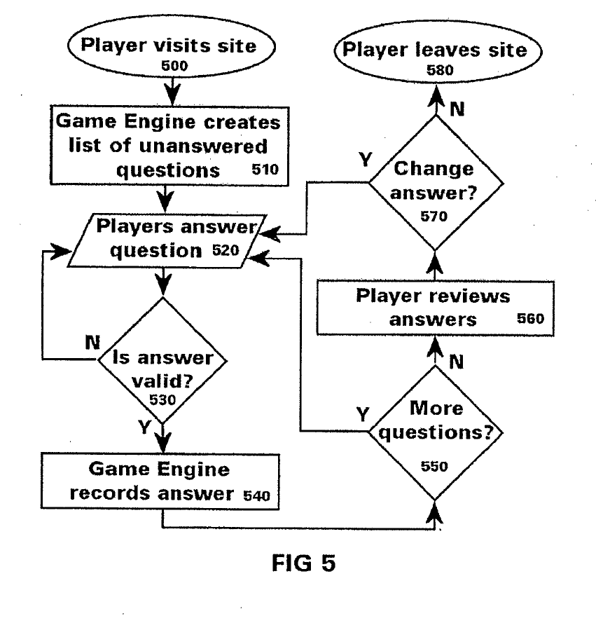

FIG. 5 is a block diagram showing how players participate in the game by answering questions. When a player visits the Web site 500 the game engine creates a list of questions the player has not answered 510. The player may have the opportunity to answer all the questions 520, or may be limited to a predetermined number of questions per visit. For each question the player answers the game engine validates the answer 530 for a variety of factors, and if the answer is valid, the game engine records the answer 540. Once there are no more questions to answer, or the player chooses to stop answering questions, 550 the player may be presented with a review of the recorded answers 560 and the opportunity to change those answers 570. In some circumstances previously answered questions can be reviewed 560 and changed 570 as well. Finally, the player leaves the Web site 580.

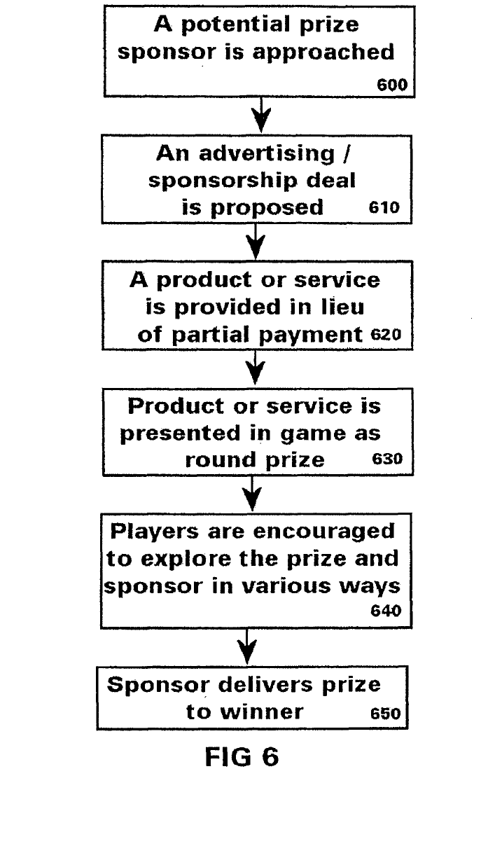

FIG. 6 is a block diagram describing how advertisers/sponsors participate the game by making their products or services available as a prize. A current advertiser or a new potential advertiser/sponsor is approached with an offer to become a sponsor 600. A sponsorship package is proposed 610 where products or services are offered as a partial payment for the advertising contract 620. This product or service becomes a game prize 630, and it features prominently in various places on the Web site. The prize is strongly promoted, and the player is encouraged to explore both the prize itself and the sponsor 640 by various means, including information on the Web site and links to the sponsor's Web site. At the end of a game round when the prize is won, the sponsor delivers that prize to the winner 650.

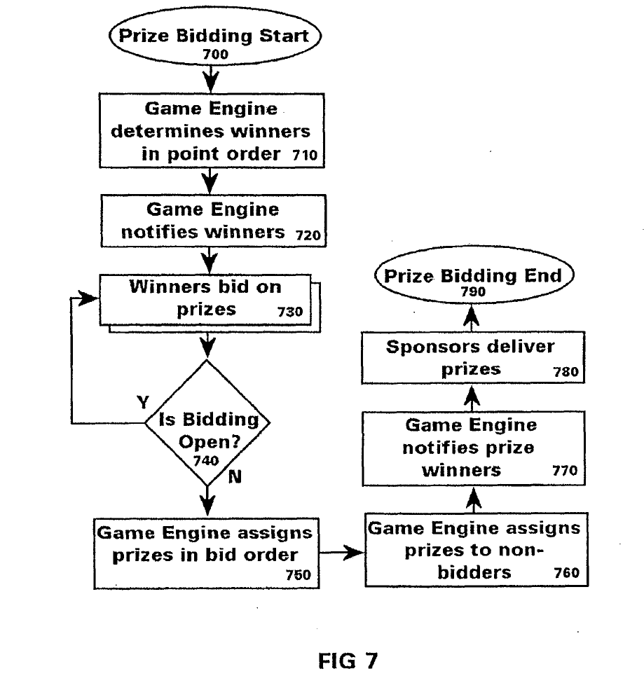

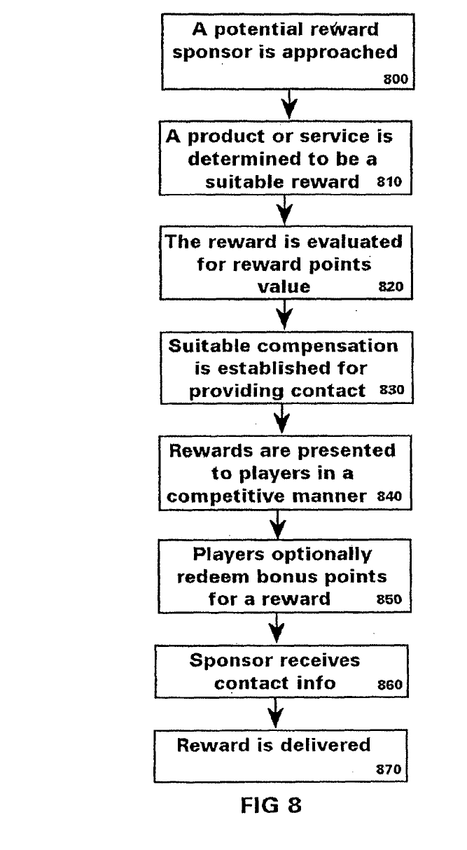

FIG. 7 is a block diagram showing the process of prize bidding. Bidding begins 700 after a game round ends. The game engine ranks all players in point order, using a tie-breaking method in the event two players have equal points, and determines the prize winners by selecting and ranking a number of top points earners equal to the number of prizes available 710. The game may notify winners via e-mail 720, as well as by putting an alert in their browser client when they visit the site. Winners may bid on prizes 730 in the following manner: Winners are presented with the full selection of prizes and requested to select a number of prizes, in order of their preference, equal to their position as points earner. For example, the first place points earner need only choose one prize, the second place needs to choose two prizes, etc. This bidding process continues until the time allotted for bidding expires 740. The game engine examines the bids in order of points earned and assigns the highest choice prize that is available to that points earner 750. In the event there are winners who have not entered a bid for a prize, the remaining prizes will be assigned to the non-bidding winners 760 in descending order by market value. The game engine notifies all prize winners of the prize they were assigned 770, and the sponsor delivers the prize 780. The bidding process is over 790 after prize delivery 780 is completed.

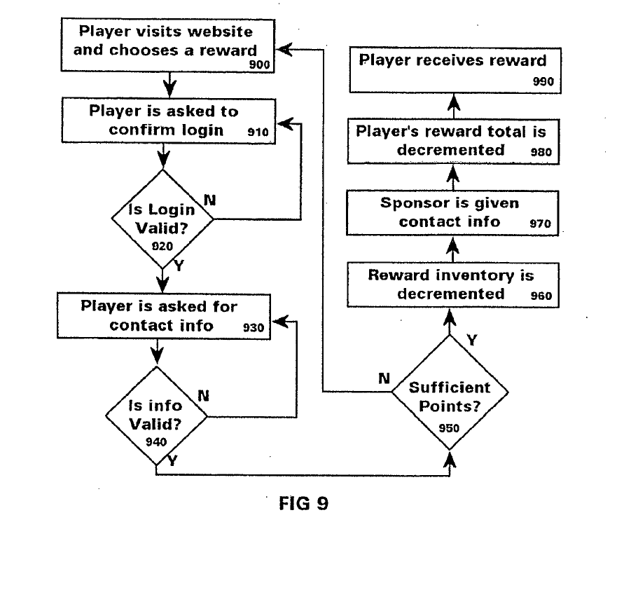

FIG. 8 is a block diagram describing how advertisers/sponsors participate in the game by making their product or service available as a reward. A current advertiser or new potential advertiser/sponsor is approached with an offer to become a sponsor 800. A product or service is determined to be a suitable reward for the redemption of reward points 810. The reward is evaluated to determine the number of points that would need to be redeemed 820. The amount of compensation for creating the contact between the player and the sponsor is established 830. This reward is presented on the Web site in a competitive manner 840. Players have the option to redeem their reward points for rewards 850. When an award is redeemed the sponsor receives the contact information 860. The reward request is fulfilled and the reward is delivered to the player 870.

FIG. 9 is a block diagram showing how a player redeems reward points for a reward. Once on the Web site the player chooses a desired reward 900 from the competing offers. The game engine requests the player confirm the login 910. The game engine verifies the login 920 and asks the player to provide, or confirm existing, contact information 930 such as address and telephone number. The game engine validates the contact information 940 to a greater or lesser degree depending on country, region, etc. The game then confirms that the player have sufficient reward points to redeem for the chosen reward 950. The reward inventory is decremented 960. The sponsor is given the player's contact information 970. The player's reward points total is decremented 980. The player receives the reward 990.

In summary, the subject method provides an interesting, informative, free, Web-based prediction game that offers two tiers of prizes and rewards as incentive to continue playing over the long term. The game can be played in just a few minutes a day, during which time the customer answers questions predicting future events, but also is presented with the prizes and rewards that can be won or redeemed, as well as various other types of advertisements and offers. Sponsors have the opportunity to present their products and services to a well-defined demographic over an extended time and in a competitive manner, so that if their particular goods or service is selected, the new customer has enhanced value to the sponsor over a customer acquired via a random banner click.

The game is played on the Internet and can be perpetual in nature, running in cycles timed to the occurrence of a future random event. A Web site featuring the game is made available and publicized. Players visit the Web site and register for the game by providing an e-mail address, user name and password. They may also be asked for information of interest to advertisers, such as age, income and the like. Registered players are alerted by an optional e-mail whenever a new game event is in play. Game questions ask players to forecast events, in various categories of, for example, politics, economics, art and entertainment, science, social issues and sports. The possible answers may be a single choice, multiple choices or ordered depending upon the question's description. Points are assigned to the event question and possible answers and reflect various weighted elements such as potential societal impact and the probability of an occurrence that a game master and/or odds makers attach to the event. These points may be hidden from users or displayed, depending on the type of question. At each cycle conclusion, all earned points attributable to each registered contestant are tabulated and arranged in descending order by contestant placement. Prizes may be provided by advertisers/sponsors who are solicited for ads and game prize sponsorships for each game cycle. Winning players are matched to the number of sponsor prizes offered in the game cycle. These players may then be invited to rank their preferences for the sponsor prizes. The prizes are distributed according to their rankings. Winning players who do not submit preference rankings or whose ranked choices are all selected by higher-scoring players may be assigned the remaining prizes by value in order of their placement. The points of these players are then liquidated. Those players not eligible for prizes in the prize award cycle may retain their points as reward points. Those points are transferred to a point bank from which they can redeem points for goods or services offered as advertiser/sponsor rewards. Players may also save their reward points to bid in an annual StarProg silent auction. A new game cycle may begin immediately upon the completion of the prior cycle.

Rewards points may also be earned in other ways. For example, trivia questions may be offered. Groups of players may form teams and compete in the prediction game together, with prizes and rewards points offered based on a variety of measures, such as overall scores, improvement, and scores within leagues based on the characteristics of various teams, for example, age or geographic region. Groups of events may be formed into series, with prizes and rewards points offered for the best individuals and teams over a number of different game rounds. Finally, points might be earned by wagering them in games of skill or chance against other players or against a computer model.

In one embodiment, sponsors are invited to participate in the claimed method by supplying goods or services that are either awarded to players as prizes or available to players for redemption as rewards. In the case of prizes, the value of the goods or services may be credited against the cost of an advertising campaign on the Web site. In the case of rewards, the sponsor may compensate the game's proprietor for providing the player's contact information to the sponsor when points are redeemed. In both cases, the sponsor and the sponsor's goods or services are featured prominently on the Web site for an extended period of time in a competitive manner with other goods and services offered by other sponsors to foster a sense of value to the player. Information about the goods and services is provided both on-site and via links to the sponsor's sites. When players are awarded prizes, they actually bid on the goods or services they want, thus enhancing the sense of value and ownership. When a player redeems reward points for sponsor rewards, these points have distinct value to the player; further, since the potential rewards are presented in a competitive manner, when the particular reward is redeemed, the customer already has a connection to the sponsor. By receiving the player's contact information, the sponsor is further able to cement the relationship.

Sponsors may also raise their profile and improve public relations by, for instance, offering to donate money to charitable causes on behalf of players who themselves donate rewards points, or providing their goods and services to charitable causes instead of to players when directed to do so by a player redeeming rewards points.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method of marketing products of others, comprising:
(a) providing a Web server that can be accessed by players over a telecommunications network;
(b) providing a game master component which allows players who have accessed said Web server to play a game and to award points to said players based on said play;
(c) providing game engine software associated with said game master component;
(d) soliciting sponsors to provide products to be used as prizes and rewards to be given to players playing said game; and
(e) allowing players to select specific prizes and rewards based on said points that are of interest to them, thereby placing sponsors products with players which are demographically suited for and interested in said products.

2. The method of claim 1 comprising the further step of awarding points to said players based on their performance in the game.

3. The method of claim 1 wherein said game requires the prediction of a future event.

4. The method of claim 3 wherein said players are required to play said game again at a later time to determine if their prediction is correct.

5. The method of claim 2 wherein prizes are awarded to the highest scoring players in a defined period of play, and rewards are obtained by redemption of said points accumulated over an extended period of time.

6. The method of claim 5 wherein said points are only awarded to said players to whom said prizes are not awarded at the end of said defined period of play.

7. The method of claim 1 wherein said sponsors provide said prizes and said rewards directly to said players.

8. The method of claim 2 wherein the points awarded in a single period of play are insufficient to acquire a reward,

9. The method of claim 1 wherein said games feature advertisements related to said prizes and rewards.

10. The method of claim 1 wherein said players provide information about themselves before being permitted to play.

11. The method of claim 1 wherein said sponsors are provided with said information of said players in exchange for a fee.

12. The method of claim 1 wherein said game consists of trivia questions.

13. The method of claim 12 wherein said trivia questions include questions about said sponsors' products.

14. The method of claim 12 wherein said players have a predetermined amount of time to answer said trivia questions.

15. The method of claim 1 further comprising the steps of grouping a plurality of said players to form a team, assigning each of said players a score based on performance in said game, aggregating said plurality of players' scores to form a team score, and awarding prizes and points to said team based on said team score.

16. The method of claim 1 further comprising the steps of grouping a plurality of said games to form a series, aggregating said games' outcomes to form a series outcome, and awarding prizes and points based on said series outcome.

17. The method of claim 2 comprising the further steps of permitting said players to gamble with said points.

18. The method of claim 17 wherein said gambling takes place using other said players as opponents.

19. The method of claim 17 wherein said gambling takes place using a computer program as an opponent.

20. The method of claim 2 including the further step of permitting said players to use said points to bid in an auction for rewards.

21. The method of claim 2 including the further step of allowing said players to donate said points to charity, whereupon said sponsors provide either money, goods, or services to said charity.
